(19) United States
(12) Patent Application Publication
(10) Pub. No.: US 2026/0070386 A1
(43) Pub. Date: Mar. 12, 2026

(54) SHOCK ASSEMBLY AND METHOD FOR DETERMINING A POSITION OF AN INTERNAL FLOATING PISTON OF A SHOCK ASSEMBLY

(71) Applicant: ELKA SUSPENSION INC., Boucherville (CA)

(72) Inventors: Jean-Philippe DEXTRAZE, La Prairie (CA); Guillaume CARON, Levis (CA); Leandre JONCAS, Saint-Roch (CA); Simon FISSETTE, La Pocatiere (CA)

(21) Appl. No.: 19/260,381

(22) Filed: Jul. 4, 2025

Related U.S. Application Data
(60) Provisional application No. 63/692,227, filed on Sep. 9, 2024.

(51) Int. Cl. B60G 15/06

(52) U.S. Cl. CPC B60G 15/062; B60G 2204/112; B60G 2400/252; B60G 2400/71; B60G 2401/172

(57) ABSTRACT

A shock assembly includes a damper chamber; a piston rod received in the damper chamber; a damping piston connected to the piston rod, moveable within the damper chamber, and defining first and second chamber portions; an internal floating piston defining a third chamber portion, being disposed between the second and third chamber portions, and being axially moveable between first and second positions; a fluid received in the first and second chamber portions; a pressuring unit received in the third chamber portion; a magnetic element connected to the internal floating piston; first and second hall sensors configured to respectively provide first and second position readings of the internal floating piston based on a position of the magnetic element; and a processor communicatively connected to the first and second hall sensors and being configured to determine a position of the internal floating piston based on the first and second position readings.

### CROSS-REFERENCE TO RELATED APPLICATION

The present application claims priority to U.S. Provisional Patent Application No. 63/692,227 , filed Sep. 9, 2024, entitled “Shock Assembly and Method for Determining a Position of an Internal Floating Piston of a Shock Assembly”, which is incorporated by reference herein in its entirety.

### TECHNICAL FIELD

The present technology relates to suspension systems, more specifically to shock assemblies and methods for determining a position of an internal floating piston of a shock assembly.

### BACKGROUND

Suspension systems can come equipped with shock assemblies, which conventionally include piston rods, internal floating pistons and damping fluid, the latter of the two being configured to damp movement of the piston rods.

Conventionally, it can be difficult to determine and/or monitor information such as position and speed pertaining to the piston rods.

Thus, there is a desire for a technology that can overcome at least some of the above-described drawbacks.

### SUMMARY

It is an object of the present technology to improve at least some of the inconveniences present in the prior art.

According to one aspect of the present technology, there is provided a shock assembly including a damper chamber; a piston rod at least partially received in the damper chamber; a damping piston that is connected to the piston rod, that is axially moveable within the damper chamber, and that defines a first chamber portion and second chamber portion, an internal floating piston that defines a third chamber portion, that is disposed between the second chamber portion and the third chamber portion, and that is axially moveable between a first position and a second position; a fluid received in the first chamber portion and the second chamber portion; a pressuring biasing unit received in the third chamber portion; a magnetic element connected to the internal floating piston; a first hall sensor configured to provide a first position reading of the internal floating piston based on a position of the magnetic element; a second hall sensor configured to provide a second position reading of the internal floating piston based on the position of the magnetic element; and a processor communicatively connected to the first hall sensor and to the second hall sensor, the processor being configured to determine a position of the internal floating piston based on the first position reading and the second position reading.

In some embodiments, at least one of the first hall sensor is disposed proximate to the first position; and the second hall sensor is disposed proximate to the second position.

In some embodiments, a range of motion of the magnetic element is defined between the first position and the second position, and at least one of the first hall sensor is disposed outside of the range of motion, and the second hall sensor is disposed outside of the range of motion.

In some embodiments, the processor is configured to determine a position of the piston rod based on the position of the internal floating piston.

In some embodiments, the shock assembly further includes a temperature sensor communicatively connected to the processor, the temperature sensor being configured to sense a temperature of the fluid, and the processor being configured to factor the sensed temperature of the fluid for determining the position of the piston rod.

In some embodiments, the temperature sensor is in direct contact with the fluid.

In some embodiments, the shock assembly further includes a temperature sensor communicatively connected to the processor, the temperature sensor being configured to sense a temperature of the damper chamber, and the processor being configured to factor the sensed temperature of the damper chamber for determining the position of the piston rod.

In some embodiments, the temperature sensor is in direct contact with the damper chamber.

In some embodiments, the magnetic element is one of selectively connected to the internal floating piston, and integral with the internal floating piston.

In some embodiments, the shock assembly further includes an external reservoir fluidly coupled with the damper chamber, the internal floating piston being received in the external reservoir.

In some embodiments, the external reservoir is fluidly connected to the damper chamber by a flexible conduit.

In some embodiments, the first hall sensor and the second hall sensor are connected to the external reservoir.

In some embodiments, the first hall sensor and the second hall sensor are connected to the damper chamber.

In some embodiments, the shock assembly further includes a resilient element, a first end of the resilient element being connected to the damper chamber, and a second end of the resilient element being connected to the piston rod.

In some embodiments, the resilient element is a spring.

In some embodiments, at least one of the fluid is an oil, and the pressuring unit is nitrogen gas.

In some embodiments, the first hall sensor and the second hall sensor have equal but opposite sensitivity values.

In some embodiments, the shock assembly further includes a printed circuit board including the first hall sensor, the second hall sensor and an analog to digital converter operatively connected to the first hall sensor and the second hall sensor.

According to another aspect of the present technology, there is provided a method for determining a position of an internal floating piston of a shock assembly, the method including obtaining, by a first hall sensor, a first position reading of a magnetic element connected to the internal floating piston, obtaining, by a second hall sensor, a second position reading of the magnetic element connected to the internal floating piston, and determining the position of the internal floating piston using the first position reading and the second position reading.

In some embodiments, the method further includes determining a position of a piston rod connected to the internal floating piston based on the position of the internal floating piston.

In some embodiments, the method further includes determining a temperature of a fluid received in a damper chamber, the damper chamber having the internal floating piston received therein, and where the determining the position of the piston rod factors in the temperature of the fluid.

In some embodiments, the method further includes determining a temperature of a damper chamber, the damper chamber having the internal floating piston received therein, where the determining the position of the piston rod factors in the temperature of the damper chamber.

In some embodiments, the method is excutable by a processor.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification, the singular form “a”, “an” and “the” include plural referents unless the context clearly dictates otherwise.

As used herein, the term “about” and “generally” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view of a shock assembly according to an embodiment of the present technology, the shock assembly including a piston rod, a damper chamber, an external reservoir and a printed circuit board;

FIG. 2 is a schematic view of the shock assembly of FIG. 1, with the piston rod being in a first position relative to the damper chamber;

FIG. 3 is a schematic view of the shock assembly of FIG. 1, with the piston rod being in a second position relative to the damper chamber;

FIG. 4 is a perspective view of the printed circuit board connected to the external reservoir of the shock assembly of FIG. 1 according to an embodiment of the present technology;

FIG. 5 is a perspective view of the printed circuit board connected to the external reservoir of the shock assembly of FIG. 1 according to an other embodiment of the present technology;

FIG. 6 is a cross-sectional perspective view of a temperature sensor received in the external reservoir, according to an alternative embodiment of the shock assembly of FIG. 1;

FIG. 7 is a schematic view of a shock assembly according to an alternative embodiment of the present technology;

FIG. 8 is a schematic view of a shock assembly according to an other alternative embodiment of the present technology;

FIG. 9 is a schematic view of readings of hall sensors of the shock assembly of FIG. 1, the readings being depicted with respect to a position of a magnetic element of the shock assembly of FIG. 1;

FIG. 10 is a schematic view of readings of hall sensors of the shock assembly of FIG. 1, the readings being depicted with respect to a position of a magnetic element of the shock assembly of FIG. 1 moving along a larger range of motion; and

FIG. 11 is a schematic view of four shock assemblies connected to a single processor.

Unless otherwise noted, the Figures may not be drawn to scale.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

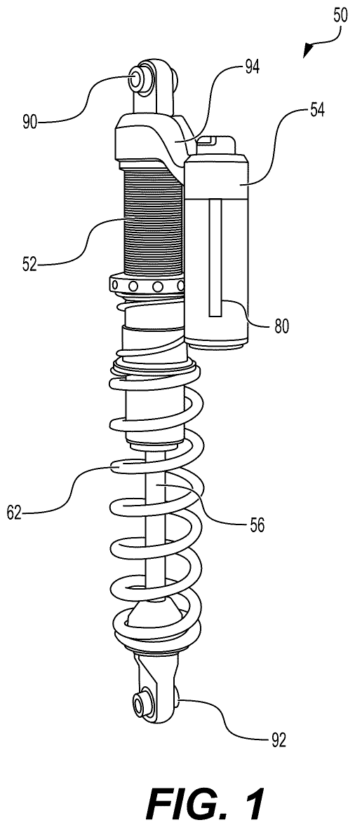

A shock assembly 50 according to an embodiment of the present technology is shown in FIG. 1. The shock assembly 50 is configured to be part of a suspension system of a vehicle (not shown) for dampening impacts and vibrations when the vehicle is in operation.

Referring to FIGS. 1 to 3, the shock assembly 50 has a damper chamber 52, an external reservoir 54 fluidly connected to the damper chamber 52, a piston rod 56 which is partially received in, and moveable with respect to, the damper chamber 52, and a coil spring 62. The shock assembly 50 also includes a damping piston 58, an internal floating piston 60, a magnetic element 70, and a printed circuit board 80 and a processor 88, all of which will be described in greater detail below. As will also be described below, the processor 88 is configured to determine information such as position and/or speed of the piston rod 56 and/or of the damping piston 58 based on a position of the internal floating piston 60 by using the magnetic element 70 and hall sensors 82, 84, which are disposed on the printed circuit board 80.

The damper chamber 52 is a hollow body made of a non-ferromagnetic material such as, but not limited to, aluminum, in which the damping piston 58, part of the piston rod 56 and a damping fluid are received. The damping fluid is an oil, but it is contemplated that other incompressible fluids may be used. Two chamber portions 100, 102 are defined within the damper chamber 52 by the damping piston 58. As will be described below, the chamber portions 100, 102 are configured to vary in volume in response to a movement of the damping piston 58. The damper chamber 52 has, at a top thereof, an upper connecting eyelet 90. The upper connecting eyelet 90 enables the shock assembly 50 to connect to part of the suspension system or to the vehicle.

Below the upper connecting eyelet 90, a connector 94 connects the damper chamber 52 to the external reservoir 54. More specifically, the connector 94 rigidly and fluidly connects the damper chamber 52 to the external reservoir 54. The fluid connection is provided by a conduit defined within the connector 94. The connector 94 may be provided with a selectively operable valve for controlling passage of fluid through the conduit of the connector 94. Thus, in the illustrated embodiment, the shock assembly 50 is a piggyback shock assembly. As will be described below, it is contemplated that the shock assembly 50 may be another type of shock assembly such as an internal floating shock absorber or a remote reservoir shock assembly.

Still referring to FIGS. 1 to 3, the piston rod 56 extends out of a lower end of the damper chamber 52, and is moveable with respect thereto. A lower connecting eyelet 92 is disposed at a lower end of the piston rod 56. The lower connecting eyelet 92 enables the shock assembly 50 to connect to part of the suspension system or to the vehicle (e.g., to a ground-engaging member of the vehicle). The piston rod 56 is also connected to the coil spring 62.

More specifically, the coil spring 62 has one end connected to the piston rod 56, above the lower connecting eyelet 92, and one end connected to the exterior of the damper chamber 52. The coil spring 62 winds around the piston rod 56 and the damper chamber 52. It is contemplated that in some embodiments, the coil spring 62 could be replaced by another resilient member, such as, for example, a polymeric material. In other embodiments, the coil spring 62 may be replaced by a pressurized gas chamber. In yet other embodiments, the coil spring 62 may be omitted. The coil spring 62 can assist in limiting movement of the piston rod 56 relative to the damper chamber 52, and can bias relative movement between the piston rod 56 and the damper chamber 42 toward a given position.

The damping piston 58 is connected to the piston rod 56, and as mentioned above, is received within the damper chamber 52 and defines the chamber portions 100, 102. The damping piston 58 defines an aperture 96 to allow some passage of the damping fluid therethrough.

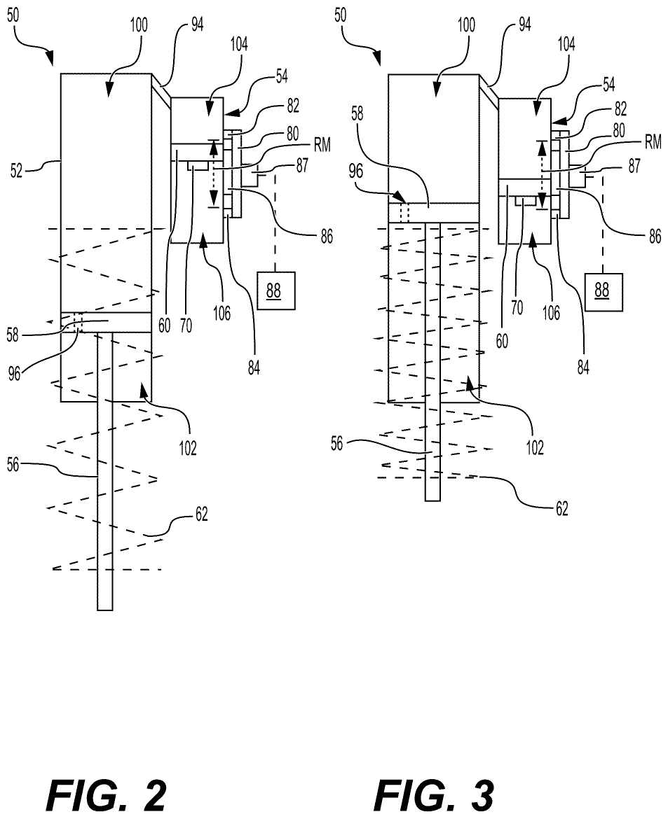

The external reservoir 54, similarly to the damper chamber 52, is made of a non-ferromagnetic material such as, but not limited to, aluminum. The internal floating piston 60 is received in the external reservoir 54, such that reservoir portions 104, 106 are defined within the external reservoir 54. The reservoir portion 104 may be referred to as an extension reservoir portion or a proximate reservoir portion, and the reservoir portion 106 may be referred to as a pressuring reservoir portion or a distal reservoir portion. The internal floating piston 60 is moveable, with respect to the external reservoir 54, between a retracted position, which can also be referred to as compressed position, (shown in FIG. 2) and an expanded position, which can also be referred to as an extended position, (shown in FIG. 3). Volumes of the reservoir portions 104, 106 change in response to the internal floating piston 60 moving. The reservoir portion 104 is fluidly connected to the chamber portion 100 via the connector 94, such that the reservoir portion 104 also contains the damping fluid. In some instances, the reservoir portion 104 and the chamber portion 100 may be considered as being one continuous chamber. The reservoir portion 106 has a pressuring unit disposed therein for applying pressure on the internal floating piston 60. In some instances, the pressuring unit may be referred to as a biasing unit. In the present embodiment, the pressuring unit is nitrogen gas. As will be described in greater detail below, an influx of the damping fluid into the reservoir portion 104 causes the internal floating piston 60 moves toward the expanded position resulting in the volume of the reservoir portion 106 to decrease and the pressure in the reservoir portion 106 to increase. The nitrogen gas applies a force on the internal floating piston 60 to prevent cavitation. Other pressuring units may include springs.

The magnetic element 70 is connected to the internal floating piston 60. In the present embodiment, the magnetic element 70 is selectively connected to the internal floating piston 60 via an adhesive. It is contemplated that the magnetic element 70 could be connected to the internal floating piston 60 differently, for example with a fastener. In some embodiments, the magnetic element 70 could be permanently connected to the internal floating piston 60. In yet other embodiments, the magnetic element 70 and the internal floating piston 60 may be integral (e.g., the internal floating piston 60 and the magnetic element 70 may be manufactured together).

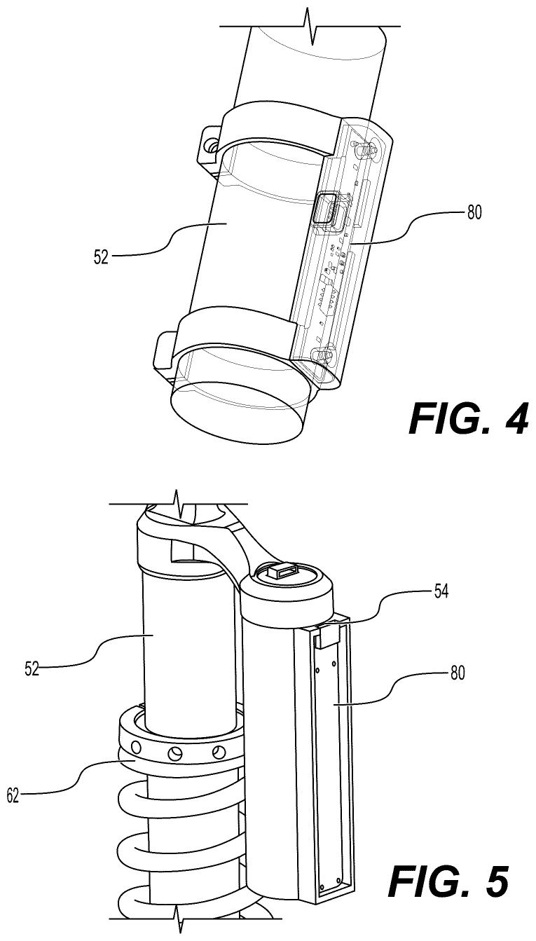

The printed circuit board 80 will now be described in greater detail. The printed circuit board 80 is disposed on the exterior surface of the external reservoir 54. In some embodiments, the printed circuit board 80 could be connected to the external reservoir 54 via fasteners. In some embodiments, as shown in FIG. 4, the fasteners may be collars 98. Fasteners such as collars 98 enable the printed circuit board 80 to be integrated to existing shock assemblies. In other embodiments, as shown in FIG. 5, the printed circuit board 80 may be integrated into a housing of the external reservoir 54. It is also contemplated that in other embodiments, the printed circuit board 80 may be disposed elsewhere. For example, the printed circuit board 80 may be disposed on the damper chamber 52.

In this embodiment, the printed circuit board 80 includes the two hall sensors 82, 84, a temperature sensor 86, and an analog-to-digital converter (ADC) 87. However, in some embodiments, one or more of the two hall sensors 82, 84, the temperature sensor 86, and the ADC 87 may be separate from the printed circuit board 80. The printed circuit board 80 is operatively connected to the processor 88. In some embodiments, the processor 88 may be part of the printed circuit board 80.

The hall sensors 82, 84 are spaced from one another along an axial direction of the external reservoir 54. That is, the hall sensors 82, 84 are spaced from one another along a direction of movement of the internal floating piston 60. Because the magnetic element 70 is connected to the internal floating piston 60, the hall sensors 82, 84 can also be said to be spaced from one another along a direction of movement of the magnetic element 70. The hall sensor 82 is positioned near the retracted position of the internal floating piston 60 whereas the hall sensor 84 is positioned near the expanded position of the internal floating piston 60. Specifically, the hall sensors 82, 84 are positioned outside of a region defined between the expanded and retracted positions, where the region between the expanded and retracted positions may be referred to as a range of motion RM (schematically illustrated in FIGS. 2 and 3) of the internal floating piston 60. Thus, the hall sensors 82, 84 can also be said to be positioned outside of a range of motion of the magnetic element 70. It is contemplated that in some embodiments, the hall sensor 82 and/or the hall sensor 84 may be aligned with their respective retracted and expanded positions. In yet other embodiments, the hall sensor 82 and/or the hall sensor 84 may be inside the range of motion of the magnetic element 70. It is contemplated that the hall sensors 82, 84 may be provided on the external reservoir 54 as standalone sensors.

The hall sensors 82, 84 are communicatively connected to the ADC 87. In some embodiments, the hall sensors 82, 84 may be directly connected to the processor 88. The hall sensors 82, 84 can also be said to be operatively connected to the magnetic element 70. Indeed, based on the position of the magnetic element 70, the hall sensor 82 is configured to provide first position readings of the internal floating piston 60, and the hall sensor 84 is configured to provide second position readings of the internal floating piston 60. It will be appreciated that the readings provided by the hall sensors 82, 84 are not altered by the damper chamber 52 and/or by the external reservoir 54, as they are both made of non-ferromagnetic material. It will further be noted that the hall sensors 82, 84 have equal but opposite sensitivity values, which, as will be described below, can assist in determining position of the piston rod 56.

The temperature sensor 86 is communicatively connected to the ADC 87. It is contemplated that in other embodiments, the temperature sensor 86 may be directly connected to the processor 88. The temperature sensor 86 is configured to measure a temperature of the external reservoir 54 for estimating a temperature of the damping fluid. As will be described below, the temperature of the damping fluid impacts the position of the internal floating piston 60. To this end, the temperature sensor 86 is in thermal contact with the external surface of the external reservoir 54, then, an approximated temperature of the damping fluid can be determined by the processor 88 based on the external temperature of the external reservoir 54.

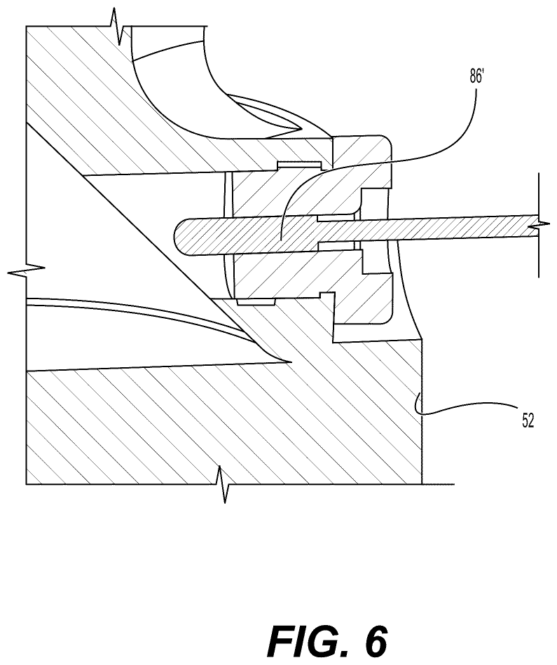

It is contemplated that in alternative embodiments, referring to FIG. 6, the temperature sensor 86′ may be a temperature probe 86′ that extends into the housing of the external reservoir 54 (without extending into the reservoir portions 104, 106 such that the temperature probe 86′ is not in contact with the damping fluid). This may assist in providing a better approximation of the temperature of the damping fluid. In yet further embodiments, the temperature sensor may be a probe configured to extend into the reservoir portion 104 for directly measuring a temperature of the damping fluid. It is contemplated that the temperature sensor 86 may be disposed elsewhere. For example, in some embodiments, the temperature sensor 86 may extend into one of the chamber portions 100, 102.

The readings of the hall sensors 82, 84 and the temperature sensor 86 are transmitted to the ADC 87. The ADC 87 converts the readings and transmits them to the processor 88. As schematically illustrated in FIGS. 2 and 3, the ADC 87 is communicatively connected to the processor 88 via wiring, but it is contemplated that the ADC 87 and the processor 88 may be connected wirelessly. Thus, the processor 88 is communicatively connected to the hall sensors 82, 84 and to the temperature sensor 86 via the ADC 87. In some embodiments, the ADC 87 may be omitted.

The processor 88 may be a single processor or may be a plurality of cooperating processors. The processor 88 may be connected to a memory device or a plurality of memory devices, an input interface or a plurality of input interfaces, and/or a wireless communication interface. The wireless communication interface may, for example and without limitation, support WiFi, Bluetooth™, 4G and/or 5G transmission technologies or low-power wide area Spidermesh technology, using a wireless radio protocol.

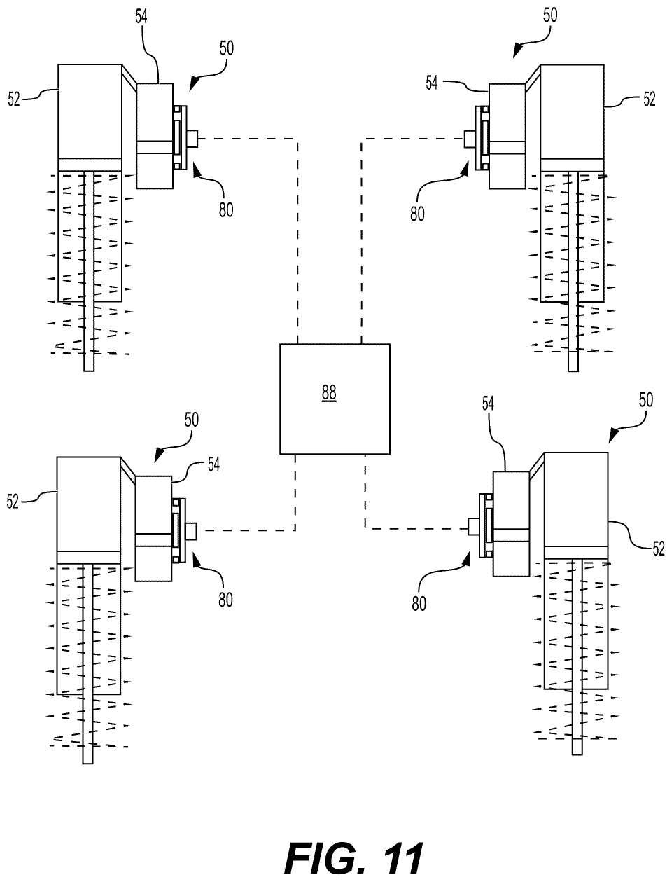

As shown in FIG. 11, the processor 88 is connected to four shock assemblies 50. It is contemplated that the processor 88 may be connected to a single shock assembly, two shock assemblies, three shock assemblies, or five or more shock assemblies 50. It will be appreciated that an aspect of the present technology enables a single cable to extend between the processor 88 and each shock assembly 50. This can assist in reducing clutter, facilitating assembly and facilitating maintenance.

As will be described in greater detail below, the processor 88 is configured to determine information pertaining to the piston rod 56 and/or to the damping piston 58 based on the position of the internal floating piston, the position of which is determined via the hall sensors 82, 84, and by factoring the expansion of the damping fluid based on temperature read by the temperature sensor 86.

It will be appreciated that with the magnetic element 70, the hall sensors 82, 84 and the processor 88 all being configured to selectively connect to the shock assembly 50, they may be retro-fitted onto an existing shock assembly.

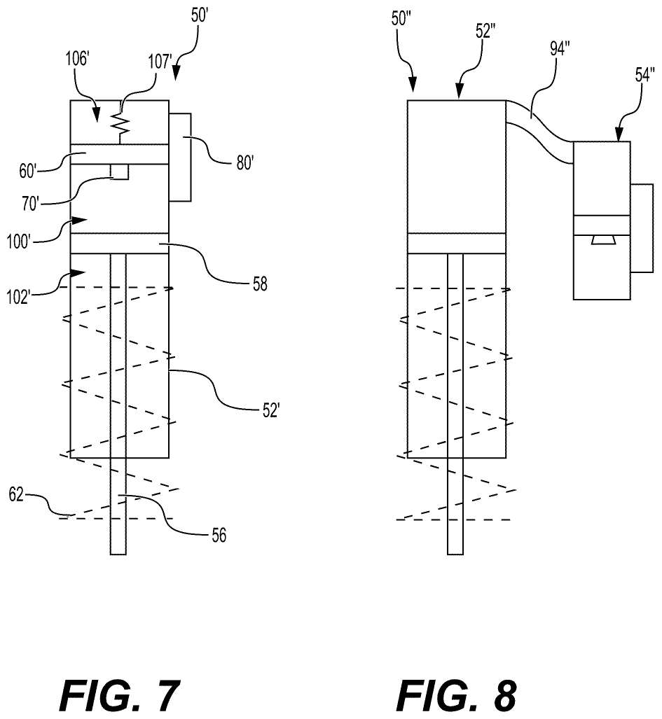

Referring to FIG. 7, an alternative embodiment of the shock assembly 50′ will be briefly described. In this embodiment, the external reservoir 54 is omitted, such that the shock assembly 50′ is an internal floating shock absorber. The internal floating piston 60′, to which the magnetic element 70′ is connected, is received in the damper chamber 52′, such that the damper chamber 52′ defines chamber portions 100′, 102′, 106′. The shock assembly 50′ has a spring assembly 107′ that is disposed in the chamber portion 106′ and that is operatively connected to the internal floating piston 60′. The spring assembly 107′ is a pressuring unit, and replaces nitrogen. The spring assembly 107′ is configured to pressure the working fluid to prevent cavitation during operation. The printed circuit board 80′ is disposed on the exterior surface of the damper chamber 52′.

Referring to FIG. 8, an alternative embodiment of the shock assembly 50″ is shown. The shock assembly 50″ notably differs from the shock assembly 50 in that the damper chamber 52″ is connected to the external reservoir 54″ via the connector 94″, which is a long flexible conduit, such that the shock assembly 50″ is a remote reservoir shock assembly.

Referring to FIGS. 2, 3 and 7, a description of the shock assembly 50 in operation, along with how a position of the piston rod 56 is determined, will now be provided.

In response to the piston rod 56 moving relative to the damper chamber 52 such that the upper and lower connecting eyelets 90, 92 come closer to one another, the volume of the chamber portion 100 decreases whereas the volume of the chamber portion 102 increases. Additionally, as the piston rod 56 enters the damper chamber 52, the volume occupied by the piston rod 56 within the damper chamber 52 increases. As a result, some of the damping fluid received within the chamber portion 100 flows toward the chamber portion 102 via the aperture 96, and some of the damping fluid flows from the chamber portion 100 toward the reservoir portion 104 via the connector 94, which in turn, causes the internal floating piston 60 to move toward the expanded position. The movement of the internal floating piston 60 toward the expanded position results in an increase in pressure applied to the internal floating piston 60 by the presence of nitrogen (i.e., the pressuring unit) in the reservoir portion 106.

As the internal floating piston 60 moves toward the expanded position, so does the magnetic element 70, since the internal floating piston 60 and the magnetic element 70 are fixedly connected to one another. The hall sensors 82, 84 each provide readings based on a magnetic field of the magnetic element 70. The magnetic field of the magnetic element 70 varies according to the distance between the magnetic element 70 and the hall sensors 82, 84.

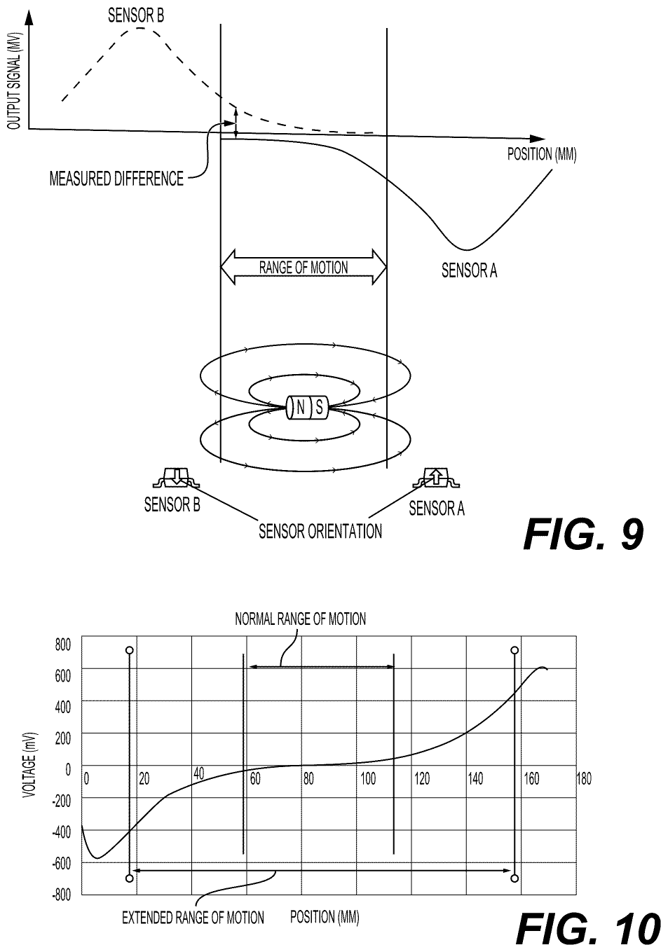

Referring to FIG. 9, the hall sensors 82, 84 are spaced and the magnetic element 70 is sized such that each hall sensors 82, 84 provides readings along its exponential range instead of its linear range. Additionally, being that the hall sensors 82, 84 have opposite output signs, treatment of the outputs is simplified, as a difference between the readings taken along the exponential range by the hall sensors 82, 84 has a linear relationship with respect to the position of the magnetic element 70. Thus, the measured difference, which is typically in volts, can easily be converted to a positional value. 0

Referring to FIG. 10, it is contemplated that in some embodiments, the range of motion of the magnetic element 70 could be extended. In such instances, the output (the difference between the readings of the hall sensors 82, 84) may lose its linear relationship with respect to the position of the magnetic element 70, but may nonetheless remain proportional. Thus, conversion between the output and the position of the magnetic element 70 can be determined following a calibration process.

In some instances, where the range of motion of the magnetic element 70 is further increased, additional hall sensors may be used. In such instances, the processor 88 would have to treat the measured readings to obtain a position of the magnetic element 70.

Once the position of the magnetic element 70 is known, being that the movement of the internal floating piston 60 is proportional to the movement of the piston rod 56, a position of the piston rod 56 may be determined.

In the present embodiment, the processor 88 is configured to factor the expansion of the damping fluid, which can have an impact on the position of the piston rod 56. The expansion of the damping fluid can be determined by measuring its temperature, and thus, via the temperature sensor 86.

Thus, the processor 88 can determine the piston rod 56 position based on the readings of the hall sensors 82, 84 and by factoring in the expansion of the damping fluid. In some instances, the processor 88 may be configured to trigger a given action. For example, in some embodiments, the processor 88 may be configured to cause actuation of a valve disposed on the connector 94 for allowing or limiting passage of fluid therethrough (i.e., allowing or limiting passage of the damping fluid between the chamber portion 100 and the reservoir portion 104).

On the other hand, in response to the piston rod 56 moving relative to the damper chamber 52 such that the upper and lower connecting eyelets 90, 92 move away from one another, the volume of the chamber portion 100 increases whereas the volume of the chamber portion 102 decreases. Some damping fluid flows from the chamber portion 102 toward the chamber portion 100 via the aperture 96, and some damping fluid flows from the reservoir portion 104 toward the chamber portion 100.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A shock assembly comprising:
a damper chamber;
a piston rod at least partially received in the damper chamber;
a damping piston connected to the piston rod, the damping piston being axially moveable within the damper chamber, and defining a first chamber portion and second chamber portion;
an internal floating piston defining a third chamber portion, the internal floating piston being disposed between the second chamber portion and the third chamber portion, and being axially moveable between a first position and a second position;
a fluid received in the first chamber portion and the second chamber portion;
a pressuring unit received in the third chamber portion;
a magnetic element connected to the internal floating piston;
a first hall sensor configured to provide a first position reading of the internal floating piston based on a position of the magnetic element;
a second hall sensor configured to provide a second position reading of the internal floating piston based on the position of the magnetic element; and
a processor communicatively connected to the first hall sensor and to the second hall sensor, the processor being configured to determine a position of the internal floating piston based on the first position reading and the second position reading.

2. The shock assembly of claim 1, wherein at least one of:
the first hall sensor is disposed proximate to the first position; and
the second hall sensor is disposed proximate to the second position.

3. The shock assembly of claim 1, wherein:
a range of motion of the magnetic element is defined between the first position and the second position, and
at least one of:
the first hall sensor is disposed outside of the range of motion; and
the second hall sensor is disposed outside of the range of motion.

4. The shock assembly of claim 1, wherein the processor is configured to determine a position of the piston rod based on the position of the internal floating piston.

5. The shock assembly of claim 4, further comprising a temperature sensor communicatively connected to the processor, the temperature sensor being configured to sense a temperature of the fluid, and the processor being configured to factor the sensed temperature of the fluid for determining the position of the piston rod.

6. The shock assembly of claim 5, wherein the temperature sensor is in direct contact with the fluid.

7. The shock assembly of claim 4, further comprising a temperature sensor communicatively connected to the processor, the temperature sensor being configured to sense a temperature of the damper chamber, and the processor being configured to factor the sensed temperature of the damper chamber for determining the position of the piston rod.

8. The shock assembly of claim 7, wherein the temperature sensor is in direct contact with the damper chamber.

9. The shock assembly of claim 1, wherein the magnetic element is selectively connected to the internal floating piston or integral with the internal floating piston.

10. The shock assembly of claim 1, further comprising an external reservoir fluidly coupled with the damper chamber, the internal floating piston being received in the external reservoir.

11. The shock assembly of claim 10, wherein at least one of:
the external reservoir is fluidly connected to the damper chamber by a flexible conduit; or the first hall sensor and the second hall sensor are connected to the external reservoir.

12. The shock assembly of claim 1, wherein the first hall sensor and the second hall sensor are connected to the damper chamber.

13. The shock assembly of claim 1, further comprising a resilient element, a first end of the resilient element being connected to the damper chamber, and a second end of the resilient element being connected to the piston rod.

14. The shock assembly of claim 1, wherein at least one of: the fluid is an oil, and the pressuring unit is nitrogen gas.

15. The shock assembly of claim 1, wherein the first hall sensor and the second hall sensor have equal but opposite sensitivity values.

16. The shock assembly of claim 1, further comprising a printed circuit board including the first hall sensor, the second hall sensor and an analog to digital converter operatively connected to the first hall sensor and the second hall sensor.

17. A method for determining a position of an internal floating piston of a shock assembly, the method comprising:
obtaining, by a first hall sensor, a first position reading of a magnetic element connected to the internal floating piston;
obtaining, by a second hall sensor, a second position reading of the magnetic element connected to the internal floating piston; and
determining the position of the internal floating piston using the first position reading and the second position reading.

18. The method of claim 17, further comprising determining a position of a piston rod connected to the internal floating piston based on the position of the internal floating piston.

19. The method of claim 18, further comprising:
determining a temperature of a fluid received in a damper chamber, the damper chamber having the internal floating piston received therein, and
wherein the determining the position of the piston rod factors in the temperature of the fluid.

20. The method of claim 18, further comprising:
determining a temperature of a damper chamber, the damper chamber having the internal floating piston received therein, and
wherein the determining the position of the piston rod factors in the temperature of the damper chamber.
